(19) United States
(12) Patent Application Publication
(10) Pub. No.: US 2012/0323644 A1
(43) Pub. Date: Dec. 20, 2012

(54) System And Method For Providing Discounted Products, Product Trials, and Product Samples

(75) Inventor: Joseph Custer, Minneapolis, MN (US)

(73) Assignee: Young America Corporation, Norwood Young America, MN (US)

(21) Appl. No.: 13/495,104

(22) Filed: Jun. 13, 2012

Related U.S. Application Data
(60) Provisional application No. 61/497,261, filed on Jun. 15, 2011.
(60) Provisional application No. 61/542,918, filed on Oct. 4, 2011.
(60) Provisional application No. 61/558,102, filed on Nov. 10, 2011.

(51) Int. Cl. G06Q 30/02

(52) U.S. Cl. 705/14.1

(57) ABSTRACT

A method utilizing a computer-implemented platform to provide, in electronic form, a notification to a consumer of the availability of one or more products on a discounted basis, receive, from the consumer in electronic form, a selection of one or more of the products, and provide a certificate to the consumer entitling the consumer to obtain the selected one or more products on a free or reduced cost basis. The certificate may, for example, be provided in an electronic format or may be a magnetic strip card. The certificate may be reloadable, such that it can be subsequently modified and associated with subsequent offers for one or more products on a discounted basis. In additional or alternative embodiments, the certificate is a single load multiple transaction certificate, wherein the certificate is initially loaded with a predetermined value, which decrements in predetermined portions based on triggering events.

### FIELD OF THE DISCLOSURE

The present disclosure relates to systems and methods used for marketing products to consumers. More specifically, the present disclosure relates to systems and methods for providing products to consumers in trial or sample form.

### BACKGROUND OF THE DISCLOSURE

Numerous methods for marketing products to consumers are known in the art. These include, for example, television and radio commercials, direct mailings, electronic mail, billboards, and other publicly displayed media, among others. One particularly effective method for marketing products to consumers is the provision of samples or trials to the consumer at no (or reduced) cost to the consumer. In this manner, the consumer gets a first hand experience of the benefits of the product, without financial risk (or reduced risk) if the consumer ultimately decides that they do not have a preference for such product. As opposed to the traditional media forms described above, product marketing based on the consumer experiencing the actual product is known and appreciated in the art to have a high success rate, measured by the number of consumer's who try the product that ultimately make a purchase of the product.

However, there are a variety of known difficulties that exist with regard to traditional marketing systems and methods that employ product trials or samples. One particular difficulty is the manufacturing of a trial or sample size(s) of the product, in addition to the regular retail size(s) of the product. That is, product trials or samples are generally much smaller than the retail size of the product, and therefore the manufacturer must expend an extra effort and incur an additional expense to create the product in a size that is suitable for consumer trials or sample. Often, therefore, additional packaging, machinery, and manpower is required to produce product sample sizes, in addition to the same expenses being incurred for the traditional product sizes. There is also a requirement for additional warehousing space to store and process the sample products prior to shipping them to the consumer. Further incurred costs include those associated with packaging and mailing a large amount of samples, such as postage and other handling costs. Such manufacturing, warehouse, and postage costs can be significant and/or prohibitive to both large and small scale manufacturers. It is also inherent when using traditional mailing systems that sample product may be misdirected (e.g., sent to untargeted consumers), undeliverable (e.g., sent to invalid addresses), or misdelivered (e.g., sent to incorrect addresses due, for example, to Post Office error).

Another known difficulty that exists with regard to traditional marketing systems and methods that employ product trials or samples is the means for distribution of such product trials or samples. For example, one common method of distribution is through the mail. However, mass mailing inevitably results in sample product being mailed to consumers who have no interest in the product, or who have no use for the product (for example, a milk-based food product sample, such as yogurt, would likely not be well-received by a lactose-intolerant consumer). Thus, the result of such mass-mailings is a significant amount of wasted product, which means a significant waste of money for the manufacturer.

A further known difficulty that exists with regard to traditional marketing systems and methods that employ product trials or samples is the limited types of products that can be provided to consumers through the mail. That is, products such as perishable items (food, beverages, etc.), frozen items, fragile items, or items that are not easily divisible into smaller trial sizes are not readily susceptible to distribution through the mail, because either the product would go bad by the time it reached the consumer, or because the product is too large to practicably send through the mail.

Due to all of the foregoing difficulties and expenses that are incurred in traditional sample marketing methods, it is becoming increasingly infrequent for manufacturers or retailers to employ such marketing methods. Thus, what is needed in the art are improved systems and methods for product marketing that overcome one or more of the above-described difficulties. Particularly, what is needed in the art are systems and methods that allow manufacturers to market their products through the use of trials or samples, but that do not require the use of additional machinery and packing to create sample sizes, and do not require the expense and effort of traditional distribution means, such as mass-mailings. In addition, what is needed in the art are systems and methods that allow manufacturers to market perishable items, frozen items, fragile items, and the like through the use of trials or samples products.

### BRIEF SUMMARY OF THE DISCLOSURE

In one embodiment, disclosed herein is an electronically-implemented method for providing a product on a discounted basis. The method includes utilizing a computer-implemented platform to provide, in electronic form, a notification to a consumer of the availability of one or more products on a discounted basis, receive, from the consumer in electronic form, a selection of one or more of the products, and provide a certificate to the consumer entitling the consumer to obtain the selected one or more products on a free or reduced cost basis. The notification may be provided, for example, by email, web page link, or smartphone application. In some embodiments, the notification is provided by a third-party entity associated with a retailer or manufacturer of one or more of the available products. In some cases, the certificate is provided in an electronic format, and may be printable by the consumer. In alternative embodiments, the certificate may be a magnetic strip card. The certificate may include one or more SKU codes indicating the products selected. In still further embodiments, the certificate may be reloadable, such that it can be subsequently modified to be associated with subsequent offers for one or more products on a discounted basis. In yet additional or alternative embodiments, the certificate is a single load multiple transaction certificate, wherein the certificate is initially loaded with a predetermined value, which decrements in predetermined portions based on triggering events. The predetermined value may be decremented in predetermined portions according to a predetermined redemption schedule. The product available on a discounted basis can be a standard retail size of the product.

In another embodiment, disclosed herein is a computer-implemented platform for providing a product on a trial basis. The platform may include a database configured for storing consumer information and product information regarding products to be offered to consumers on a discounted basis in a computer-readable storage medium. The platform may also include a processor configured to provide, in electronic form, a notification to a consumer of the availability of one or more products on a discounted basis, and receive, from the consumer in electronic fin in, a selection of one or more of the products. The platform also includes a certificate entitling the consumer to obtain the selected one or more products on a free or reduced cost basis. The computer-implemented platform is often connected to an electronic network, such as the Internet, wherein one or more of providing a notification and receiving a selection is accomplished by transmitting data in electronic form over said network. The certificate may, for example, be in an electronic format or may be a magnetic strip card. The certificate may be reloadable, such that it can be subsequently modified to be associated with subsequent offers for one or more products on a discounted basis. In additional or alternative embodiments, the certificate may be a single load multiple transaction certificate, wherein the certificate is initially loaded with a predetermined value, which decrements in predetermined portions based on triggering events. In some cases, the predetermined value is decremented in predetermined portions according to a predetermined redemption schedule.

In yet another embodiment, disclosed herein is a method of product marketing. The method may include receiving, in electronic format, an indication of selection of one or more products from a consumer, providing to the consumer a certificate entitling the consumer to receive the selected one or more products, wherein the certificate comprises electronically readable information regarding the one or more selected products, and validating the certificate upon the consumer's use thereof at a retail location. Validation may be based on electronic information received from the retail location via a network, and the received information may include at least some or all of the electronically readable information on the certificate.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 is a diagram representing the inter-relationships between the parties-at-interest in accordance with one embodiment of the present disclosure.

FIG. 2 is a diagram of a computer-implemented system in accordance with one embodiment of the present disclosure.

FIG. 3 is a flow diagram of a method in accordance with one embodiment of the present disclosure.

### DETAILED DESCRIPTION

The present disclosure relates to systems and methods used for marketing products to consumers. More specifically, the present disclosure relates to systems and methods for providing products to consumers in trial or sample form or at a discounted price. Generally, in some embodiments, a consumer may receive a notification indicating that one or more products are available in trial or sample form or at a discounted price, such as by presentation to a retailer of a token or certificate indicating that the consumer is eligible for the discounted price. The notification may be provided by any business entity, including, but not limited to, a manufacturer of one or more of the available products, a retailer of one or more of the available products, or a third-party operating in coordination with either or both of the manufacturer or retailer. In some embodiments, in response to such notification, the consumer may indicate a selection of one or more of the available products for which the consumer is desirous of receiving a trial or sample or at a discounted price. The consumer may provide the selection to any business entity, including, but not limited to, a manufacturer of one or more of the available products, a retailer of one or more of the available products, or a third-party operating in coordination with either or both of the manufacturer or retailer. In some embodiments, in response to the selection, the consumer may receive a certificate entitling the consumer to receive the one or more selected products without cost, or at a reduced cost, to the consumer. The certificate may be provided in any form, for example, paper form, electronic form, magnetic card form, including reloadable or reusable magnetic cards, or other form. The certificate may be provided to the consumer by any business entity, including, but not limited to, a manufacturer of one or more of the available products, a retailer of one or more of the available products, or a third-party operating in coordination with either or both of the manufacturer or retailer. In some embodiments, the consumer may use the certificate to obtain the commercial-sized version of the product (not just a sample or trial size) from a retailer, for example at a store location or through an internet website of the retailer, or through the mail, using the certificate. Alternatively, the consumer may obtain the product from the manufacturer, for example through an internet website of the manufacturer or through the mail, using the certificate. Further alternatively, the consumer may obtain the product from a third party, which may be associated with a retailer or manufacturer, using the certificate. In some embodiments, one or more of the retailer, manufacturer, or the third-party may optionally be reimbursed for some or all of the costs incurred in association with the provision of the product to the consumer by one or more of the other entities (retailer, manufacturer, or third-party entity), as may be agreed upon by the involved entities.

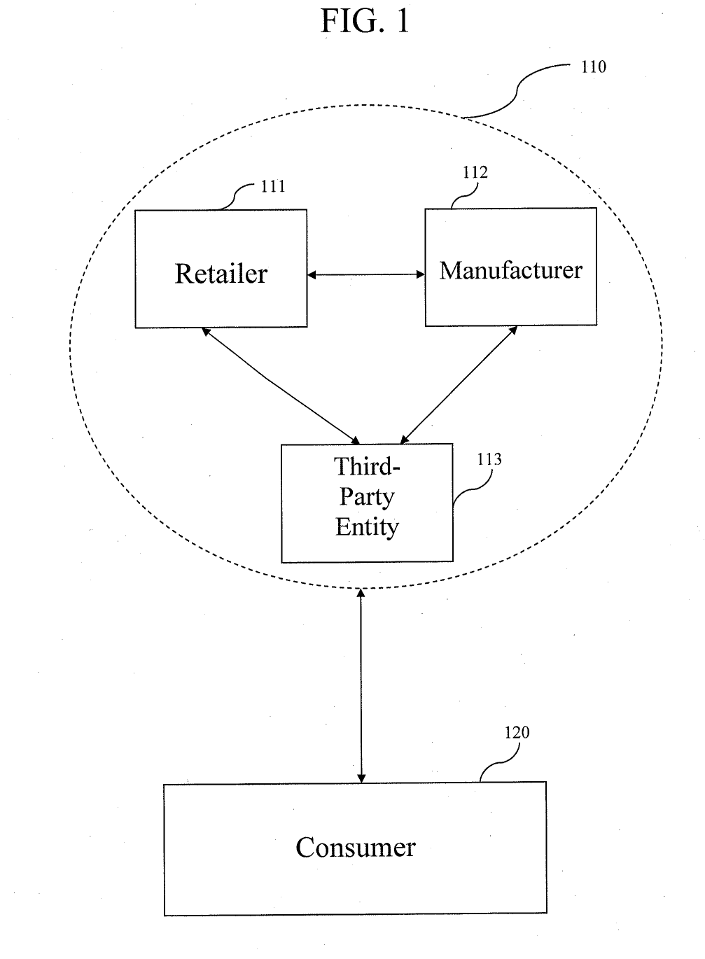

FIG. 1 depicts a conceptual relationship diagram illustrating the relationships between the parties-at-interest to the present disclosure. As shown therein, in some embodiments, an association of one or more entities 110 involved in the marketing of one or more products through the provision of trials, samples, or discounted prices may communicate with one another information regarding products to be offered for trial or sample or at discounted prices, information regarding the provision of notice regarding the availability of products for trial or sample or discounted prices, information regarding the consumers to whom such notice is provided, information regarding an indication of selection of one or more available products by the consumer, information regarding the provision of a certificate for one or more selected products to the consumer, or information regarding the costs associated with the provision of one or more products on a trial, sample, or discounted basis, among other possible communications. Entities included in the association 110 may include, but are not limited to, one or more product retailers 111, one or more product manufacturers 112, and one or more third-party entities 113, which may have a business association with either or both of the retailer 111 or the manufacturer 112. In some embodiments, information regarding the notification of products available on a trial, sample, or discounted basis, information regarding the selection of one or more such products, or information regarding the certificate (or the certificate itself) for the one or more selected products, among other things, may be communicated between one or more of the entities in the association 110 and a consumer 120, in furtherance of or in connection with the presently described systems and methods.

In some embodiments, a computer-implemented system may be provided. The computer-implemented system may be employed as a stand-alone system, or it may be employed in connection with one or more other systems that may be computer-implemented. The computer implemented system may be employed in connection with one or more procedures of the methods described in the present disclosure.

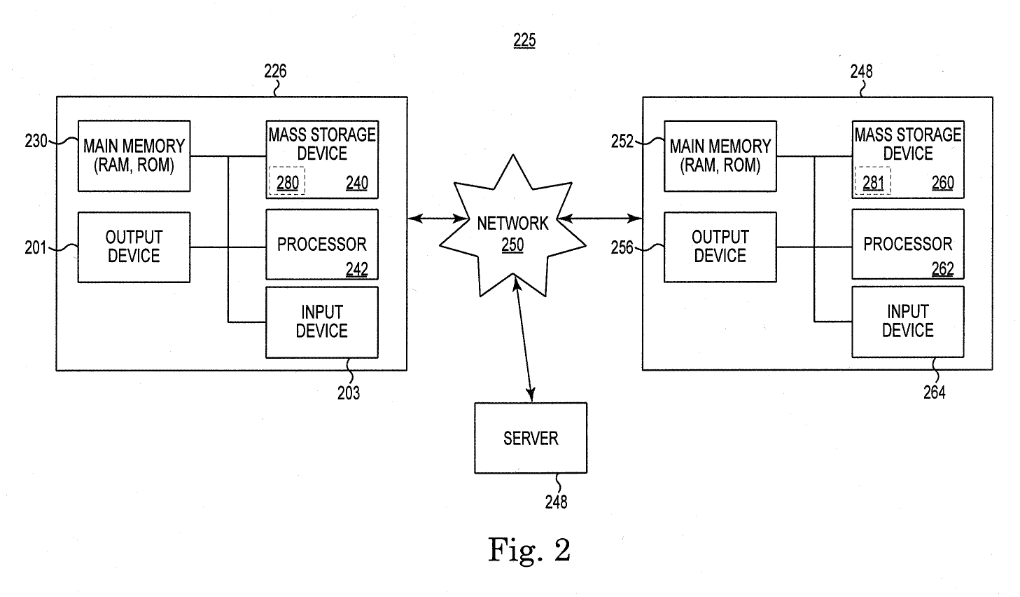

Some embodiments of the present disclosure may be implemented through one or more computing devices connected with one another through an electronic network. As shown particularly in FIG. 2, a computing device used with the present disclosure may be part of a larger network system 225 of devices. System 225 may include one or more computing devices 226 connected with a network 250, such as the Internet. Computing device 226 can interact with a server 246 in order to input and receive information, for example but not limited to, information related to the provision of one or more product trials, samples, or discounts, as described above.

System 225 may also include the ability to access one or more web site servers 248 in order to obtain content from the Internet for use with the systems and methods described herein. While only one computing device is shown for illustrative purposes, system 225 may include a plurality of computing devices 226 and may be scalable to add or remove computing devices to or from a network.

Computing device 226 illustrates components of an embodiment of a suitable computing device for use with the present disclosure. Computing device 226 may include a main memory 230, one or more mass storage devices 240, a processor 242, one or more input devices 244, and one or more output devices 236. Main memory 230 may include random access memory (RAM), read-only memory (ROM), or similar types of memory. One or more programs or applications 280, such as a web browser, and/or other applications may be stored in one or more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive, or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250. Input interface 203 may include any device for entering information into computing device 226, such as but not limited to, a microphone, digital camera, video recorder or camcorder, keys, keyboard, mouse, cursor-control device, touch-tone telephone or touch-screen, a plurality of input devices, or any combination of input devices. Output device 201 may include any type of device for presenting information to a user, including but not limited to, a computer monitor or flat-screen display, a printer, and speakers or any device for providing information in audio form, such as a telephone, a plurality of output devices, or any combination of output devices.

Applications 280, such as a web browser, may be used to access electronic information in connection with the present disclosure, for example, by connecting to a host server or other electronic device. Any commercial or freeware web browser or other application capable of retrieving content from a network and displaying pages or screens may be used. In some embodiments, a customized application 280 may be used to access, display, and update information.

A server 246, for example located at a merchant location, may also be connected to the network 250. Server 246 may include a main memory 252, one or more mass storage devices 260, a processor 262, one or more input devices 264, and one or more output devices 256. Main memory 252 may include random access memory (RAM), read-only memory (ROM), or similar types of memory. One or more programs or applications 281, such as a web browser and/or other applications, may be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keys, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, or speakers or any device for providing information in audio form, such as a telephone, a plurality of output devices, or any combination of output devices.

Server 246 may store a database structure in mass storage device 260, for example, for storing product availability or selection information, and other data. Any type of data structure can be used, such as a relational database or an object-oriented database.

Processors 242, 262 may, alone or in combination, execute one or more applications 280, 281 in order to provide some or all of the functions, or portions thereof, of the product marketing systems and methods described herein.

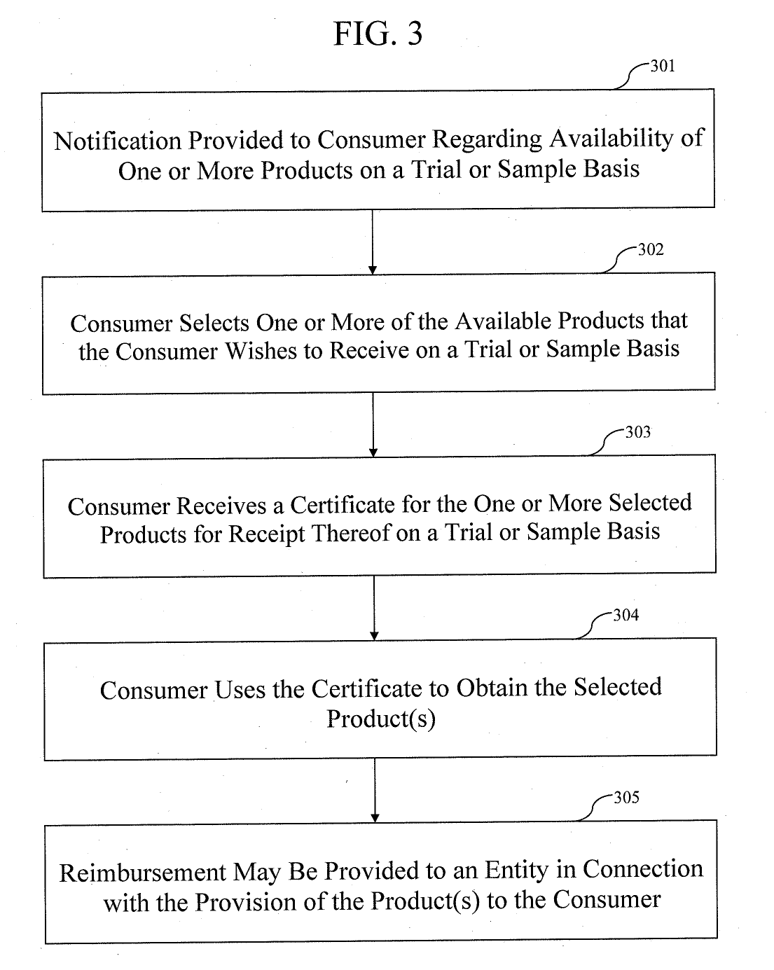

Reference is now made to FIG. 3, which illustrates a flowchart showing various procedures associated with the systems and methods of some embodiments of the present disclosure. It will be appreciated that more procedures may be performed than shown in FIG. 3. Further, it will be appreciated that fewer procedures may be performed than shown in FIG. 3. Additionally, it will be appreciated that the procedures shown in FIG. 3 need not be performed in the order shown, but may be performed in any order.

With reference to block 301, an entity or combination of entities, for example, retailers, manufacturers, or associated third parties, etc., desirous of marketing one or more products may provide a notification to one or more consumers of the availability of a trial or sample of such product or products free of charge to the consumer (or at a reduced cost from standard retail price). In some embodiments, notification may be a written or oral communication indicating the terms of the trial, sample, or discount offer and instructing consumers with regard to satisfaction of the trial, sample, or discount offer. For example, consumers may be notified of the availability of a product or products for trial, sample, or discount by a mass distributed flyer or advertisement. Such notifications may appear within printed or electronic media such as newspapers, magazines, journals and the like, internet publications or other internet websites, or any other advertising medium. Alternatively, the notifications may be in the form of an email or delivered mail or other electronic or non-electronic targeted marketing campaign. Other forms of notification, such as radio and television advertisements, are contemplated to be within the scope of the present disclosure. Still further forms of consumer notification including, for example, telephone calls, text messages, or smartphone applications, are also contemplated to be within the scope of the present disclosure. Still further forms of consumer notification may include communications through social networking sites, including, but not limited to, Facebook Groupon®, Twitter®, MySpace®, LinkedIn®, etc., or communications available through consumer loyalty programs, which may of course include any of the notification means listed above.

In some embodiments, a notification may include a listing of one or more products that are available to the consumer on a trial, sample, or discount basis, and may include one or more teems or conditions associated with such offer. Terms or conditions may include, for example, cost to the consumer (for example, free or at reduced cost), limitation on the amount of a product available on such basis, actions required on the part of the consumer to obtain such product trial, sample, or discount, locations where the product is available, or documentation required to obtain such product, among other information. Other information may be included in the notification, including information regarding the product, for example, a product description, information regarding the manufacturer, information regarding the retailer, or any other information related to the product offer.

In connection with the above-described offer of products to consumers on a trial, sample, or discounted basis, two or more of the above-described entities (retailers, manufacturers, third-parties) may enter into a business relationship to coordinate the offering of such products to consumers. In some embodiments, a retailer may partner with a manufacturer to promote a particular product in an effort to increase the sales of the product at both the retailer and the manufacturer. In other embodiments, either a retailer or manufacturer may partner with a third-party entity, such as a nationally-recognized promotional entity (Groupon®, for example, is a well-known entity engaged in the business of product promotion on behalf of retailers and manufacturers). In still other embodiments, either a retailer or manufacturer may partner with a marketing facilitation entity, for example an entity that can handle the logistics of providing notifications, providing certificates, validating certificates used by consumers, and other forms of marketing facilitation or information management. Of course, it will be appreciated that various other partnerships among two or more of the above-described entities, or other entities, are also possible. In embodiments, wherein a third-party entity is a partner, such entity may be provided a fee from either the retailer or manufacturer (or both, or other entity) for marketing facilitation services, for promotional services, or for other services. However, in other embodiments, one entity such as a retailer or manufacturer may handle the whole system alone.

Products may be selected for inclusion in a notification to the consumer for a variety of reasons. In some embodiments, a retailer, manufacturer, or third-party entity may offer a product to a consumer on a trial, sample, or discounted basis where the product is perishable, and the expiration date of such product is nearing. For example, it is common in food or other edible products to have included thereon a “sell by” date, wherein the retailer or other entity may be required to sell or otherwise dispose of a product by a date certain. It will be appreciated that in many instances, the costs associated with disposal of expired products can be quite significant. For example, costs may be incurred in storage of the product, transportation of the product, or dumping of the product (e.g., at a landfill or other waste disposal facility). Thus, it may be more cost effective for the retailer or other entity to simply give the product away prior to the expiration date, than to incur the costs associated with the disposal of the product. In another example, perishable products such as foods and beverages, which have not traditionally been available in trial or sample sizes due to the inability to send such items through the mail without them going bad (i.e., due to lack of refrigeration, etc.) may be made available as a trial or sample in accordance with the present disclosure. A consumer may travel to a retail location where such perishable products are sold, and obtain a trial or sample of the product that the consumer otherwise would not have been able to obtain due to its perishable nature.

In other embodiments, a retailer, manufacturer, or third-party entity may offer a product to a consumer on a trial, sample, or discounted basis in order to drive more consumer traffic at a retail location. For example, the offer of a free or reduced price sample or trial of a product may result in consumer finding additional products to purchase at a retail location, once they have arrived at the retail location for the purpose of obtaining the trial or sample. Trial, sample, or discounted products can be positioned within the retail location such that there are numerous other products in the vicinity thereof that may compliment the trial, sample, or discounted product, thereby potentially driving full purchases of such additional products. Consumers may also find other products at the retail location for purchase, thereby potentially increasing overall sales at the retail location.

In still other embodiments, a retailer, manufacturer, or third-party entity may offer a product to a consumer on a trial, sample, or discounted basis for traditional marketing reasons, for example, to gain exposure for a new product, an improved product, or an existing product, for example. Thus, an entity, for example, a manufacturer, can create enthusiasm and consumer interest in such products by allowing the consumer to try or sample such product on a free or reduced cost basis. Of course, a retailer, manufacturer, or third-party entity may have more than one reason for including a product in a notification to the consumer.

In embodiments where the manufacturer is the notifying party, it will be appreciated that embodiments of the present disclosure allow the manufacturer easier access to market its products to the consumer through trials and samples than has been previously available. For example, whereas retailers have retail locations where consumers travel to purchase products, thereby giving the retailer a “captive audience” for whatever marketing efforts they may wish to employ (for example, at grocery stores, it is common to see food products being sampled), manufacturers have traditionally not had available such an avenue to them for trials and samples. Thus, trial or sample marketing directed by manufacturers has been severely limited, for example, restricted to mass mailings of sample sizes for limited products, as discussed above. Embodiments of the present disclosure may allow the manufacturer to quickly set-up a notification means, for example, an Internet website, and notify customers of the products available for trials or samples on a substantially real-time basis. Thereafter, the consumers can travel to a retail location that may have no other connection with the manufacturer other than that the manufacturer's products are sold there to receive the products. Thus, the manufacturer is able to take advantage of an existing distribution network to market its products through sample, in a manner that is quick, efficient, and reduces overall costs incurred by the manufacturer in the marketing campaign.

In embodiments where the retailer is the notifying party, it will be appreciated that embodiments of the present disclosure, among other advantages, allow the retailer to notify consumers in substantially real-time through the use of the electronic notification means described above of the availability of one or more products in trial, sample, or discounted form. Whereas traditional marketing means, such as flyers, papers advertisements, etc. have a certain degree of “lag-time” involved with the printing, publishing, and distribution thereof, electronic notification means such as email and Internet web pages allow retailers to notify consumers of products generally immediately as they become available for trial, sample, or discount. Such immediate notification may allow retailers to more quickly, efficiently, and inexpensively move products that have a limited shelf life, for example, perishable products, where it is beneficial to the retailer to wait as long as possible before offering such product on a trial, sample, or discounted basis (for example, where a product is near expiration).

With reference to block 302, in response to a notification of the availability of one or more products on a trial, sample, or discounted basis, the consumer may select one or more of the available products that the consumer is desirous of receiving on a trial, sample, or discounted basis. In some embodiments, the consumer may make the selection in paper form, for example, by marking on a document (which may also be the notification document) the consumer's selection. In other embodiments, the selection may be made over the phone, for example, by calling a number indicated in the notification, and informing a representative orally, or using key-pad inputs (e.g., in response to an automated menu of options), to make the selection. In still other embodiments, the selection may be made by email, wherein the consumer indicates the selection in e-mail form and sends the email to the retailer, manufacturer, or third-party, etc. For example, the consumer may be provided with an electronic form by email, wherein the consumer can electronically select one or more products, and thereafter return the completed form electronically to the offeror. In yet another embodiment, the selection may be electronically over an electronic network, for example, the Internet, wherein the consumer may access a website operated by one or more of a retailer, a manufacturer, or a third-party to make the selection. Here as well, the consumer may be provided with an electronic form through the web page browser wherein the consumer can select one or more products, and then send such information back to the offeror by submission through the web page browser (over a network, such as the Internet). Other methods of selection, including, for example, text messaging, smartphone application, etc. are contemplated within the scope of the present disclosure. In some embodiments, the selection may be made in the same manner as the notification. Alternatively, the selection may be made in a different manner than the notification. Further yet, the user may have the option of two or more methods for making the selection. Available methods for selection may be indicated on the notification, as part of the above-described information regarding the offer of the product on a trial, sample, or discounted basis.

In some embodiments, along with the product selection, the consumer may be required to provide other information that may be useful for future marketing efforts, including, but not limited to, personal identifying information (name, address, phone number, etc.), product preferences, personal interests, information regarding consumer purchasing patterns with respect to both discounted (trial, sample) and full priced items, and other information that might be useful for marketing purposes. This data may be stored, and used to track purchasing habits, to determine consumer interest, and/or to provide other notifications or other marketing to the consumer that match the consumer's demographics, preferences, etc., or any other suitable use, which may result in more efficient and successful marketing campaigns. The data may further be used to determine consumer traffic within one or more retail locations, and the turnover on the shelf of a particular product or products within one or more retail locations.

With particular reference to embodiments wherein an Internet website is provided for the consumer to make the selection of desired available products, it will be appreciated that the website may be maintained by any entity associated with the product offering. For example, in some embodiments, the website may be maintained by the manufacturer of the product. In other embodiments, the website may be maintained by the retailer of the product. In other embodiments, the website may be maintained by a third-party entity, for example, a nationally-recognized promotional entity or a marketing facilitation entity. Of course, the website may be operated and maintained by other entities, or a combination of entities. In embodiments, wherein a third-party entity maintains the website, such entity may be provided a fee from either the retailer or manufacturer (or both, or other entity) for marketing facilitation services, for promotional services, or for other services.

Once a selection is made by the consumer, in some embodiments, the receiving entity may communicate with one or more other entities information regarding the selection, as described above with regard to FIG. 1. For example, wherein the selection information is received by a marketing facilitation entity, such entity may provide the selection information to the retailer, manufacturer, or other entity. However, in other embodiments, it will be appreciated that communication of such information is not required.

As shown at block 303, in response to the selection made by the consumer, a retailer, manufacturer, or other entity may issue to the consumer one or more certificates that allow the consumer to obtain the selected products on a trial, sample, or discounted basis. A certificate may be embodied in any form. For example, in some embodiments, the certificates may be a physical certificate, for example, a paper certificate with printed information thereon relating to the products selected. Such physical certificate may be delivered to the consumer by regular mail, express mail, or by pickup at a designated location. In another example, a physical certificate may be in the form of a card having a magnetic strip, with information stored in the magnetic strip relating to the products selected. In another example, in other embodiments, the certificate may be provided in electronic form. Electronic form may include a digital representation of a certificate, for example, that may be delivered to (and possibly printed by) the consumer by e-mail, web page link, or smartphone application, among others. Electronic form may also include digital information other than a representation of the certificate, for example, a web page link or other means that allows the consumer to directly access the selected products through an online website of the retailer, manufacturer, or other entity. Where a certificate is provided in electronic form, it will be appreciated that the consumer will then immediately be able to go to the retail location where the product is available, rather than waiting for days or weeks to receive the product through the mail. This may lead to more immediate gratification for the consumer, and therefore possibly wider adoption of trial marketing in accordance with the present disclosure.

The certificate may be configured to allow the consumer to obtain the selected product or products in a variety of manners. For example, a physical certificate may be configured to allow the consumer to physically bring the certificate into a retail location, or mail the certificate to a manufacturer, in order to obtain the product directly from the retailer (for example, at a location of the retailer) or directly from the manufacturer via the mail. Likewise, a digital representation of a certificate may be used in a similar manner, for example, after being printed by the consumer, or the consumer may simply use a portable electronic device, for example, a smartphone, to show (or send) the certificate to a retailer, manufacturer, or other entity when requesting the product. Alternatively, where the physical certificate is embodied in the form of a card having a magnetic strip thereon, the consumer may bring the card to the retailer or manufacturer location, and swipe the card through a card reading device, thereby indicating the consumer's right to obtain the selected product or products. Further, alternatively, in examples where the certificate is embodied as a web page link or other non-representative digital form, the consumer may simply be able to click on such web page link and be directed by a secure or unsecure connection to a webpage of the retailer, manufacturer, or other entity that allows the consumer to obtain the trial or sample products.

The certificate may contain information regarding the consumer's selected products thereon in any of a variety of forms. In one example, a physical certificate, whether sent to the consumer or printed by the consumer, may contain one or more Stock-Keeping Unit (SKU) codes that are readable by an optical reading device of the retailer, manufacturer, or other entity, or one or more other suitable codes that are electronically (e.g., magnetically or optically) scannable by a corresponding reading device of the retailer, manufacturer, or other entity. In this manner, the consumer may simply bring the certificates to a location of the retailer or manufacturer (or send such certificate through the mail to the retailer or manufacturer, or third-party entity), wherein the retailer or manufacturer can scan the certificate, therefore indicating the consumer's right to obtain the product or products on a trial, sample, or discounted basis. A certificate in the form of a card with a magnetic strip may be used in a similar manner, except that the card is swiped through a magnetic reader, rather than optically scanned, to determine the SKU codes or other suitable electronically scannable codes. In another example wherein a web page link is used as the “certificate,” the link itself may contain digital information identifying the consumer, the product or products selected, and other information, wherein clicking on the link directs the consumer's Internet browser to a secure or unsecure page that allows the consumer to obtain (by ordering, for example) the selected products from the retailer, manufacturer, or other entity.

As will be appreciated by those having ordinary skill in the art, SKU codes are typically specific to a particular retailer and/or a particular product. SKU codes usually represent a unique product identifier number at the particular retailer, so that the retailer can track movement and sales of the particular product. SKU codes are usually assigned to a product or group of products by a retailer, and therefore may have little or no cross-relationship among a set of retailers. SKU codes differ from Universal Product Codes (UPCs—which are the same on every product, no matter where sold, and are typically provided in barcode form) in that they are not applied to the product by the manufacturer, but are typically applied by the retailer as needed. For example, a single product may be indicated by one SKU code at a first retailer, whereas the same product may be indicated by another SKU code at a second retailer. Thus, in some embodiments, where a particular product is available at more than one retail location, the consumer may be able to select the retailer (or other location) from where the trial, sample, or discounted product or products are desired to be obtained (in addition to selecting the products themselves). In other embodiments, the consumer may be directed to a particular retail location, and the code only provided with respect to such location. The certificate sent to the consumer may then contain SKU codes specific to both the selected retailer or retailers (or other location) and the selected product or products. As will be appreciated, this may result in the certificate containing numerous SKU codes, where numerous retailers or products are selected. In other embodiments, however, selected product information may be encoded on the certificate (which may be in card form) wherein a single code can be provided to obtain a product at any retailer.

In other embodiments, information contained in one or more of the electronically-scannable codes (e.g., magnetically or optically scannable codes) of a certificate may be modified or updated, including dynamically modified or updated (for example, but not limited by, altering the magnetic strip of a reloadable or reusable magnetic card), such that the certificate may be used or reused more than a single time and may be used to obtain different products, products from different locations, and/or products during different time periods, etc. In still further embodiments, information contained in one or more of the electronically-scannable codes (e.g., magnetically or optically scannable codes) of a certificate may be used in combination with information stored in one or more entries of a database to determine a consumer's right to obtain a product or products on a trial, sample, or discounted basis. In this way, alternative to or in addition to modifying a code on the certificate, one or more database entries associated with the certificate can be modified or updated, including dynamically modified or updated, to alter the information associated with the certificate. Accordingly, where embodiments of physical certificates are limited the ability to contain modifiable codes on the faces of the certificates themselves (such as but not limited to paper certificates), the database may be additionally or alternatively used to control reloading or reusing of the certificates. The altered information may, for example, relate to a new offer for a trial, sample, or discounted product for which the consumer would like to participate. Accordingly, the consumer may continue to reuse the certificate rather than being issued a new certificate for each offer.

In some embodiments, the procedures described above with regard to blocks 301-303 may be integrated into a single electronic system or platform, such as system 225. Such platform may be operated and maintained by one or more of a retailer, a manufacturer, or a third-party entity, such as a marketing facilitation entity or a promotional entity, along or in partnership, as discussed above. Such platform may contain a database, such as data storage devices 240, 260 for storing consumer information and product information that may be used in connection with the notification of consumers with regard to the availability of products on a trial, sample, or discounted basis. Such platform may be connected via an electronic network, such as network 250, to one or more other systems, enabling the platform to send the notification to the consumer in electronic format, for example, via email, text message, electronic advertisement, smartphone application, etc. This network 250 may also allow the platform 225 to receive information back from the consumer regarding the product or products selected, in one or more of the electronic manners described above. Such information may be used to track consumer purchasing habits and/or target particular consumers or groups of consumers for future notifications or offers, as described above. Such additional offers, if accepted by a consumer, may be reloaded to, or otherwise associated with (such as by an update to a back-end database) a certificate previously issued to the consumer (such as, but not limited to, a reloadable or reusable magnetic card) so that a new certificate need not be issued, as discussed in detail above. Furthermore, in some embodiments, the platform 225 may be configured to generate certificates as described above, for example, in electronic form, and send such certificates electronically via one of the manners described above to the consumers. The data storage devices 240, 260 may store SKU information, or other product indicating information, in order to generate the certificates for sending to the consumer in response to a selection. It will be appreciated, however, that such a platform 225 is not limited to sending and receiving information in electronic form. Rather, in some embodiments, the platform 225 may be configured to operate with one or more additional systems, for example, a printing system or a mailing system, wherein the platform can direct such additional systems to provide, for example, printed notifications, printed certificates, direct mailing information, etc.

As shown in block 304, and as discussed above, once the consumer receives the certificate, in whatever form, the consumer may bring or send such certificate to a retailer, a manufacturer, or other entity in order to obtain the selected product or products. Again, the certificate can be embodied in either physical or electronic form, and the retailer, manufacturer, or other entity can read the certificate either manually, through optical scanning, through magnetic swiping, or through any other manner. In one example, a consumer may travel to a selected retailer location, obtain the selected products, and possibly additional products, and bring all of the products to a checkout register at the retail location. The consumer may then present the certificate to the cashier, wherein the consumer may have the cost of the selected products eliminated (or reduced) from the total bill. In this manner, the consumer may receive the benefit of a full-size trial or sample of the product, as the consumer would obtain if she had simply purchased the product outright, rather than just the traditional smaller sample size. This can allow the consumer to better experience the benefits of the product, therefore potentially driving subsequent purchases of the product. Furthermore, in this manner, the retailer may receive the benefit of the consumer entering their retail location, where, in addition to selecting the products for the trial, sample, or discount, the consumer may find additional products at the retail location that the consumer is desirous of purchasing, thereby driving increased sales in the retail location.

In some embodiments, an additional procedure may be performed in accordance with the present disclosure, as indicated at block 305, wherein one or more of a retailer, a manufacturer, or other entity may be provided reimbursement for some or all of the cost of the products provided to the consumer, or for some or all of the cost incurred in association with providing the products to the consumer. In one example, where a manufacturer employs the systems and methods of the present disclosure in a marketing campaign for a particular product, the manufacturer may reimburse the retailers for the cost of products provided on the trial, sample, or discounted basis. Some or all of the costs may be reimbursed in a cost sharing arrangement with the retailer, as it will be appreciated that the marketing effort may drive increased traffic to the retail location, resulting in additional purchases at the retail location. The point-of-sale (POS) system employed by the retailer may be configured to keep track of both products sold to the consumer at retail price and products offered to the consumer on a trial, sample, or discounted basis so that the retailer can receive credit (e.g., from the manufacturer or third-party entity) for the distribution of such trials, samples, or discounts, and/or so that the retailer can maintain an accurate stock of inventory. In another example, where a promotional entity is employed to direct the marketing effort (e.g., on behalf of a retailer or manufacturer), the promotional entity (such as Groupon®, for example) may be reimbursed for its services in connection with the marketing effort. In yet another example, where a marketing facilitation entity is employed to provide services in connection with the marketing effort, the marketing facilitation entity may similarly be reimbursed for its services in connection with the marketing effort.

Marketing facilitation entity services may include, for example, operation and maintenance of a platform as described above. Additionally, marketing facilitation entity services may include, for example, certificate clearing and validation services, wherein each time a certificate is used, the entity clears and validates the certificate to prevent fraudulent use of certificates, and to ensure that a particular consumer is entitled to the particular product on a trial, sample, or discounted basis. Thus, the marketing facilitation entity may maintain an electronic connection with the retailer and/or manufacturer, such that certificate information obtained at the point of sale (e.g., through scanning or swiping) may be transmitted to the entity for clearance and validation. Using this information, the marketing facilitation entity may optionally be able to provide reimbursement information to retailers and manufacturers, wherein the marketing facilitation entity can provide the manufacturer with information regarding the number of products obtained from a particular retail location on a trial, sample, or discounted basis, and reimbursements can be made to the retailer based on that information.

As discussed above, certificates in accordance with the present disclosure may allow a consumer to obtain one or more products on a trial, sample, or discounted basis, wherein the cost of the product is free, or at a reduced price as compared to standard retail price. Where the price is reduced, the retailer of manufacturer may be able to recoup some or all of the money spent in manufacturing or purchasing the product. In one example, where a retailer is desirous of clearing a stock of perishable product that is near its expiration date, the retailer may provide a notification of the availability of such product, in accordance with the systems and methods of the present disclosure, on a trial, sample, or discounted basis, and at a reduced cost that is near or equal to the cost the retailer spent in obtaining (e.g., purchasing) the product from the manufacturer. In this manner, the retailer may be able to “break even,” substantially “break even,” or at least recoup some costs, with respect to the costs of the product, and avoid expenses that would be incurred in disposal of the product. The retailer also receives the benefit of increased consumer traffic, and potential repeat sales if the consumer enjoys the product.

In further embodiments, certificates in accordance with the present disclosure may allow the consumer to select from among a variety of products on a trial, sample, or discounted basis, wherein the total cost of whatever products are selected is reduce by a fixed amount. In one example, a retailer, manufacturer, or other entity may provide a notification to a consumer that a “basket” of products are available for selection, wherein the total cost of such products up to a certain limit may be reduced by a fixed amount. For example, a certificate may allow the consumer to obtain, for example, fifty dollars worth of products selected from a basket of available products for only twenty-five dollars (e.g., a fifty percent or twenty-five dollar reduction from retail price). In another example, a certificate may allow the consumer to select a fixed number of items from the basket at a specified price. In yet another example embodiment, a basket of products for selection may include products that are currently selling well, along with other products that may not be selling well, such that the consumer may be drawn to select a variety of such products, thereby broadening the consumer's knowledge of existing products.

With reference now to a procedure that a consumer may follow in accordance with one embodiment of the present disclosure, the consumer may first receive a notification of the availability of a product or products on a trial, sample, or discounted basis from a retailer, a manufacturer, or a third-party entity through an electronic communication means, such as email or a web page browser. The consumer may then make a selection of one or more products for which the consumer is desirous of obtaining a trial or sample. This selection may be made in electronic form, for example using an electronically provided form received in the email or web page browser notification. The electronic form, with selections made, may be electronically returned to the offeror through email or through the web page browser. Thereafter, the consumer may substantially immediately, or shortly thereafter, receive a certificate, provided in electronic form, to obtain the selected product(s) at a retail location. In other embodiments, where a consumer has previously received a certificate, the previously received certificate or information associated with the previously received certificate may be updated to reflect the selection(s) made, as discussed in detail previously. The consumer may immediately print the certificate, or use the updated previously received certificate, and go to the retail location to receive the product trial(s) or sample(s), rather than waiting for days or weeks to receive the product(s) through the mail.

In yet further embodiments, a certificate in accordance with the present disclosure may be what is referred to herein as a single-load multiple transaction certificate, such as but not limited to a single-load multiple transaction magnetic card or the like. The terms “single-load multiple transaction” are not limiting and are meant only as a representative moniker for a particular embodiment of the present disclosure; of course, irrespective of this moniker, the “single-load multiple transaction” certificate could be loaded, or reloaded, more than a single time as discussed above, and likewise, the “single-load multiple transaction” certificate could be used in a single or multiple transactions. The single-load multiple transaction certificate may be loaded or preloaded with, or otherwise associated with, a predetermined amount or value. Triggering events or transactions may cause decrements in the total amount or value of the single-load multiple transaction certificate, or cause predetermined portions of the total amount or value of the single-load multiple transaction certificate to be removed from the single-load multiple transaction certificate or otherwise disassociated with the single-load multiple transaction certificate. The triggering events or transactions may be any type of triggering event or transaction, such as any of the transactions described herein with respect to trial, sample, or discounted products. The predetermined amount or value loaded on, or associated with, the single-load multiple transaction certificate may be configured for covering multiple triggering events or transactions, including triggering events or transactions happening at separate times and/or different locations.

Rules may be associated with the single-load multiple transaction certificate that identify or indicate the consumer's eligibility for the trial, sample, or discount associated with a triggering event or transaction. Rules for the triggering events or transactions may be used to set up any eligibility or authentication requirements, such as but not limited to, the location of the triggering event or transaction, the date and/or time of the triggering event or transaction, the cumulative number of triggering events or transactions for which the certificate was used, the temporal distance between triggering events or transactions, the type or quantity of product being sought during a triggering event or transaction, the discount sought during a triggering event or transaction, etc. Furthermore, rules may be deleted, modified, added, etc. at any time. In some embodiments, once the initial predetermined amount or value has been used up or otherwise disposed, the single-load multiple transaction certificate may be reloaded, for example at the request of the consumer by the various methods described herein, with a further value, and accordingly, the rules may be modified with, or replaced with, a new set of rules associated with the further value.

As an example illustration, similar to the process described with respect to FIG. 3 above, an entity or combination of entities, for example, retailers, manufacturers, or associated third parties, etc., desirous of marketing one or more products may provide a notification to one or more consumers of the availability of the product or products at a reduced (or free) cost from standard retail price. However, unlike the process described above, such entity or combination of entities may desire to provide for multiple discounted products, which may be purchased for example at separate times or at different locations, or may desire to provide for a particular discount schedule, where multiple discounts are provided for one or more products, but are intended to be redeemed according to a particular redemption schedule, such as daily, weekly, monthly, etc., or as determined by any other suitable timing schedule. For example, a product manufacturer, retailer, or other rebate offeror may desire to offer three separate $15 rebates, one for each of three separate purchases of a particular product A. However, the rebate offeror may desire that the purchases be made at least 30 days apart from each other. In this way, the rebate offeror can, for example, build product or brand loyalty over a period of time. With a single-load multiple transaction certificate embodiment, as described above, the initial offer may include a single-load multiple transaction certificate preloaded or pre-associated with a $45 value, which is intended to be used according to a particular set of rules, indicating, for example, at least that the $45 can only be used $15 at a time for three separate purchases of product A, wherein in order to qualify for any given $15 rebate for the purchase of product A, that purchase of product A must be at least 30 days from the previous purchase of product A. Of course any number of other potential variations or other uses for a single-load multiple transaction certificate of the type described herein are contemplated and within the scope of the present disclosure.

Like block 302 of FIG. 3, in response to a notification of one or more offers, the consumer may select one or more of the available offers in any suitable manner, such as those described herein, which include but are not limited to, in paper form, over the phone, by email, electronically over an electronic network, by text message, through a smartphone application, etc. In some embodiments, single-load multiple transaction certificates associated with particular offers may be sent to targeted or random consumers without any notification and/or consumer response step.

Like block 303 in FIG. 3, in response to the selection made by the consumer, a retailer, manufacturer, or other rebate offeror or other entity may issue to the consumer one or more single-load multiple transaction certificates that allow the consumer to obtain the selected products on a trial, sample, or discounted basis, as determined by any rules associated with the single-load multiple transaction certificates. While as discussed above that a certificate may be embodied in any form, in one embodiment for example, the single-load multiple transaction certificate may be a card having a magnetic strip, with information stored in the magnetic strip or otherwise associated with the card, relating to, for example, the products selected, the preloaded and/or remaining amount or value of the card, and/or any applicable rules requirements.

Like block 304 in FIG. 3, once the consumer receives the single-load multiple transaction certificate, in whatever form, the consumer may bring such certificate to one or more retailers, manufacturers, or other entities in order to obtain the selected product or products according to the applicable rules, causing a triggering event or transaction and decrementing the value associated with the card accordingly. Of course, depending on the applicable rules, the amount or value of the single-load multiple transaction certificate may be used across a plurality of triggering events or transactions. Using the example above, a consumer may travel to the retailer location, obtain product A for a $15 discount, and possibly additional products, and bring all of the products to a checkout register at the retail location. The consumer may then present the single-load multiple transaction certificate to the cashier, wherein the consumer may have the $15 discount applied, if all requirements are met. After 30 days, the consumer may once again travel to the retailer location, obtain another product A for a $15 discount, and possibly additional products, and bring all of the products to a checkout register at the retail location. The consumer may then present the same single-load multiple transaction certificate to the cashier, wherein the consumer may have a further $15 discount applied, if all requirements are met. After yet another 30 days, the consumer may repeat the process once again and travel to the retailer location to obtain another product A for the remaining $15 discount. Of course, as indicated above, the amount or value loaded on or otherwise associated with the single-load multiple transaction certificate need not be for purchases of the same product nor for purchases with the same entity or combination of entities nor must the consumer be required to use the total value of the card.

In some embodiments, single-load multiple transaction certificates may use “just in time” funding or “fund upon spend” funding. That is, in some embodiments, a rebate offeror, such as the above rebate offeror providing a $45 rebate to be used in three separate $15 increments, may not be liable for, or otherwise billed/charged for, the rebate value unless the value was used by the consumer (and in some cases validated). Accordingly, a rebate offeror may use single-load multiple transaction certificates to offer rebates without substantial upfront funding. An established credit line may be used, in some embodiments, to provide for a method of “just in time” funding or “fund upon spend” funding.

In other embodiments, single-load multiple transaction certificates may use or require upfront funding by the rebate offeror. In such cases, should any residual value of the card be unused (for any reason) by the consumer, such residual value can be handled in any suitable manner, including but not limited to, returning or crediting the residual value to the rebate offeror.

Advantages of single-load multiple transaction certificates as disclosed herein can include, but are not limited to, funding efficiencies and operational efficiencies. Particularly, funding efficiencies may arise in that a rebate offeror can combine multiple future rebate offers, which are in some instances bound to predetermined usage schedules, in a single transaction certificate issued to each consumer, thus requiring only a single initial upfront payment of costs and/or fees associated with a single transaction certificate per consumer. This can be contrasted to traditional methods requiring multiple transaction certificates—one for each rebate offer—per consumer, which lead to multiple instances of those same upfront costs and/or fees—e.g., the costs and/or fees for multiple certificates per consumer.

Various benefits may be realized by the systems and methods of the present disclosure. For example, rather than being limited to a sample size of the product that is smaller than the traditionally sold version of the product, the consumer may be able to engage in a full size trial of the product, which may allow the consumer to better experience the product, and may result in increased adoption, increased preference, and repeat purchase behaviors with regard to the product. In another example, the availability of product trials and samples may be improved by virtue of allowing the consumer to obtain the trial or sample product from the retail location, as opposed to traditional distribution methods (for example, through the mail) that might restrict the types or kinds of products that are available to the consumer. For example, products that are perishable or products that are not easily divisible into smaller sizes have not been distributable in sample through the mail due to their perishability or large sizes. Thus, embodiments of the present disclosure allow for the inclusion of such products in trials or samples. In yet another example, benefits may be realized by the retailers and/or manufacturers by allowing them to liquidate excess inventory, and thereby save the cost of disposal of expiring or excess inventory, and possibly even recoup some of the costs incurred in connection with manufacturing or purchasing such products. In still further examples, the presently disclosed systems and methods may allow manufacturers and retailers to reduce costs and expenses involved in implementing trial or sample programs by eliminating the need for separate product sizing and packaging for samples. This may reduce the costs expended on equipment and personnel necessary to manufacture the trial or sample sizes, and it may reduce the amount of materials that the manufacturer or retailer is required to use in order to provide the consumer with a trial or sample, thereby benefiting the environment through reduced waste. This may further reduce costs with regard to postage and handling fees that would otherwise be incurred in traditional sample marketing methods. In still further examples, the retailer or manufacturer may be able to gain greater insight into consumer behavior by tracking the consumer's selection (and possibly subsequent purchase) of trial, sample, or discounted products. In this manner, the retailer or manufacturer may be better able to target products for marketing to the consumer, thereby making such marketing more relevant to the consumer, and therefore more likely to result in a positive return on investment to the manufacturer or retailer. In still further examples, the consumer is able to receive immediate gratification with regard to the product trial, sample, or discount by instant receipt of a certificate therefore (through the electronic means described above) and going to a retail location to obtain the product trial, sample, or discount at the consumer's convenience, rather than waiting for days or weeks to receive a sample through the mail.

Another form of benefit may derive from the information obtained from the consumer as compared to traditional marketing campaigns. That is, by requiring the consumer to return a form with product selections, the offeror may also require the consumer to provide other information that may be useful for future marketing efforts, including, but not limited to, personal identifying information (name, address, phone number, etc.), product preferences, personal interests, and other information that might be useful for marketing purposes.

While discussed with particular reference to trial and sample products, it is recognized that the benefits of the various embodiments of the present disclosure can be realized in various similar applications where it may be undesirable to ship a product, such as but not limited to, where a consumer can just as easily or relatively more easily obtain the product in a nearby retail location. For example, in one embodiment, the various embodiments of the present disclosure may be used in combination with the offer of a warranty pertaining to a product. If a guarantee under the warranty needs to be fulfilled, such as the replacement of the product, a certificate for a new product, which may be redeemed at a nearby retail location, may be issued to, or sent to, the consumer rather than shipping an entirely new product, which could be much bulkier and weightier, thereby advantageously providing the manufacturer or retailer with significant shipping cost savings.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

What is claimed is:

1. An electronically-implemented method for providing a product on a discounted basis, the method comprising:
using a computer-implemented platform:
providing, in electronic form, a notification to a consumer of the availability of one or more products on a discounted basis;
receiving, from the consumer in electronic form, a selection of one or more of the products; and
providing a certificate to the consumer entitling the consumer to obtain the selected one or more products on a free or reduced cost basis.

2. The method of claim 1, wherein the notification is provided by email, web page link, or smartphone application.

3. The method of claim 2, wherein the certificate is provided in an electronic format.

4. The method of claim 3, wherein the certificate is printable by the consumer.

5. The method of claim 2, wherein the certificate is a magnetic strip card.

6. The method of claim 2, wherein the certificate comprises one or more SKU codes indicating the products selected.

7. The method of claim 1, wherein the notification is provided by a third-party entity associated with a retailer or manufacturer of one or more of the available products.

8. The method of claim 1, wherein the certificate is reloadable, such that it can be subsequently modified to be associated with subsequent offers for one or more products on a discounted basis.

9. The method of claim 1, wherein the certificate is a single load multiple transaction certificate, wherein the certificate is initially loaded with a predetermined value, which decrements in predetermined portions based on triggering events.

10. The method of claim 9, wherein the predetermined value is decremented in predetermined portions according to a predetermined redemption schedule.

11. A computer-implemented platform for providing a product on a discounted basis, the platform comprising:
a database configured for storing consumer information and product information regarding products to be offered to consumers on a discounted basis in a computer-readable storage medium;
a processor configured to:
provide, in electronic form, a notification to a consumer of the availability of one or more products on a discounted basis; and
receive, from the consumer in electronic form, a selection of one or more of the products; and
a certificate entitling the consumer to obtain the selected one or more products on a free or reduced cost basis.

12. The computer-implemented platform of claim 11, wherein the platform is connected to an electronic network, and wherein one or more of providing a notification and receiving a selection is accomplished by transmitting data in electronic form over said network.

13. The computer-implemented platform of claim 11, wherein the certificate is in an electronic format.

14. The computer-implemented platform of claim 11, wherein the certificate is a magnetic strip card.

15. The computer-implemented platform of claim 11, wherein the certificate is reloadable, such that it can be subsequently modified to be associated with subsequent offers for one or more products on a discounted basis.

16. The computer-implemented platform of claim 11, wherein the certificate is a single load multiple transaction certificate, wherein the certificate is initially loaded with a predetermined value, which decrements in predetermined portions based on triggering events.

17. The computer-implemented platform of claim 16, wherein the predetermined value is decremented in predetermined portions according to a predetermined redemption schedule.

18. A method of product marketing, the method comprising:
receiving, in electronic format, an indication of selection of one or more products from a consumer;
providing to the consumer a certificate entitling the consumer to receive the selected one or more products, wherein the certificate comprises electronically readable information regarding the one or more selected products; and
validating the certificate upon the consumer's use thereof at a retail location, wherein validation is based on electronic information received from the retail location via a network, and wherein the received information comprises at least some or all of the electronically readable information on the certificate.

19. The method of claim 18, wherein the certificate is reloadable, such that it can be subsequently modified to be associated with subsequent offers for one or more products on a discounted basis.

20. The method of claim 18, wherein the certificate is a single load multiple transaction certificate, wherein the certificate is initially loaded with a predetermined value, which decrements in predetermined portions based on triggering events.
